(19) United States
(12) Patent Application Publication
(10) Pub. No.: US 2010/0293182 A1
(43) Pub. Date: Nov. 18, 2010

(54) METHOD AND APPARATUS FOR VIEWING DOCUMENTS IN A DATABASE

(75) Inventors: Anssi Kalevi Karhinen, Vantaa (FI); Otso I. Alanko, Helsinki (FI); Santosh Kumar Kalwar, Lappeenranta (FI); Oskari O. Koskimies, Helsinki (FI); Mikko T. Tarkiainen, Espoo (FI); Tanja T. Vuoksimaa, Helsinki (FI); Turkka I. Aijala, Helsinki (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/467,818

(22) Filed: May 18, 2009

(51) Int. Cl. G06F 17/30; G06F 15/16

(52) U.S. Cl. 707/759; 709/206; 707/957

(57) ABSTRACT

An approach is provided for determining documents to display and includes extracting, from metadata in a first document, data that indicates a function and a filter for determining which documents in a database may be viewed to perform the function. It is determined whether the function is to be performed. If it is determined that the function is to be performed, then display of an icon representing a second document from the database is initiated based on the filter. In some embodiments, a document is transmitted, which includes metadata that comprises data that indicates a function and a filter for determining which documents in a database may be viewed to perform the function. A message is also transmitted comprising data that indicates a recipient has permission to perform the function.

### BACKGROUND

As people rely more on their mobile devices, business processes must adapt to this new environment. In one adaptation, a distributed process is implemented as a document-flow based service on a network with mobile nodes. Metadata about the process is included in each document sent between nodes of the network. Each node is responsible for displaying the documents available on the node, indicating the state of processing associated with each document, and permitting suitable actions on the document, including forwarding to a different node in the network. The appropriate display and allowed actions at a node, however, depend on the role of a user of the node with respect to the process. The node is typically configured by selecting one of several predefined roles for the node's user and implementing the functionality for that predefined role. However, individuals do not always fit exactly into one predefined role. For example, a particular administrative assistant may be so experienced and capable that several functions of a manager are conferred to that assistant. Thus a predefined admin role will not adequately define the actual functions to be performed by that assistant. In general, predefined role definitions are too restrictive to fully describe the variations among a large number of nodes used by corresponding individuals.

### Some Example Embodiments

Therefore, there is a need for a more flexible approach to provide users with the ability to view and operate on documents outside a set of predefined roles.

According to one embodiment, a method includes extracting, from metadata in a first document, data that indicates a function and a filter for determining which documents in a database may be viewed to perform the function. It is determined whether the function is to be performed. If so, then display of an icon representing a second document from the database is initiated based on the filter.

According to another embodiment, an apparatus comprises means for extracting, from metadata in a first document, data that indicates a function and a filter for determining which documents in a database may be viewed to perform the function. The apparatus also comprises a means for determining whether the function is to be performed. The apparatus further comprises a means for initiating display of an icon representing a second document from the database based on the filter, if it is determined that the function is to be performed.

According to another embodiment, an apparatus comprises at least one processor; and at least one memory including computer program code. The memory and the computer program code are configured to, with the processor, cause the apparatus, at least, to extract, from metadata in a first document, data that indicates a function and a filter for determining which documents in a database may be viewed to perform the function. The apparatus is further caused to determine whether the function is to be performed. If it is determined that the function is to be performed, then the apparatus is further caused to initiate display of an icon representing a second document from the database based on the filter.

According to one embodiment, a computer-readable storage medium carries one or more sequences of one or more instructions which, when executed by one or more processors, cause an apparatus to perform at least extracting, from metadata in a first document, data that indicates a function and a filter for determining which documents in a database may be viewed to perform the function. It is determined whether the function is to be performed. If it is determined that the function is to be performed, then display is initiated of an icon representing a second document from the database based on the filter.

According to another embodiment, a method comprises transmitting a document that includes metadata. The metadata comprises data that indicates a function and a filter for determining which documents in a database may be viewed to perform the function.

According to yet another embodiment, an apparatus comprises a means for transmitting a document that includes metadata. The metadata comprises data that indicates a function and a filter for determining which documents in a database may be viewed to perform the function. The apparatus further comprises a means for transmitting a message comprising data that indicates a recipient has permission to perform the function.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings, in which:

FIG. 1A is a diagram of a network of participants involved in a document-flow process, according to one embodiment;

FIG. 1B is a diagram of a document flows in the network of FIG. 1A, according to one embodiment;

FIG. 2A is a diagram of a document for a document-flow based service, according to one embodiment;

FIG. 2B is a diagram of document flow for a document-flow based service, according to one embodiment;

FIG. 3 is a diagram of modules in a distributed mobile document flow system; according to one embodiment;

FIG, 4 is a diagram that illustrates resources in the distributed mobile document flow system; according to one embodiment;

FIG. 5 is a diagram of a document metadata and business data, according to one embodiment;

FIG. 6 is a diagram of a document flow for a document-flow based travel service in an organization, according to one embodiment;

FIG. 7 is a diagram of an XML document that includes filters by function, according to one embodiment;

FIG. 8A is a diagram of an view for a first function based on the filters of FIG. 7, according to one embodiment;

FIG. 8B is a diagram of an view for a second function based on the filters of FIG. 7, according to one embodiment;

FIG. 8C is a diagram of a view for a limited first function based on the filters of FIG. 7, according to one embodiment;

FIG. 9 is a flowchart of a process on a sending node, according to one embodiment;

FIG. 10 is a flowchart of a process on a receiving node, according to one embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a terminal that can be used to implement an embodiment of the invention.

### DETAILED DESCRIPTION OF EXAMPLE EMBODIMENTS

A method, apparatus, and software are disclosed for controlling views of documents at a node in a distributed document system. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to a particular document-flow based service in a business process, embodiments of the invention are not limited to this context. For example, it is explicitly anticipated that other distributed document systems can utilize embodiments of the invention, such as a variable view of a static library of documents available on a node, as well a document distribution system among multiple wired or wireless nodes alone or in some combination.

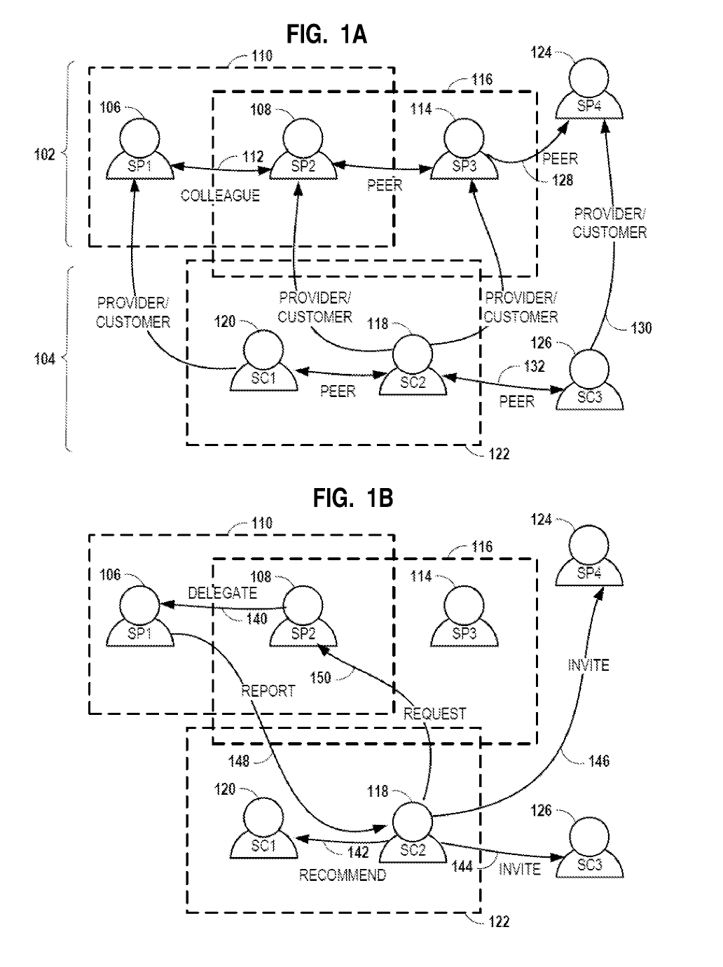

FIG. 1A is a diagram of a network of participants involved in a document-flow process, according to one embodiment. By way of illustration, it is instructive to describe processes associated with a typical business enterprise. For some time, commercial enterprises have used computer systems to automate and enhance their daily business processes. Among the first applications of computers were the basic processes found in most every enterprise: accounting, order management and customer registries. The earliest computerized solutions sought to support the generic functions of a business process such as creating, storing, and sending documents, and managing one's contact networks. As these systems developed, features were added to automate complete enterprise-wide processes in such a way that the processes can be monitored and managed in a centralized fashion. This involved defining steps and information needed from each participant of the process in unambiguous terms.

These goals eventually led to the development of Business Process Modelling (BPM) methods such as the Zachman framework from 1980. These methods try to capture all aspects that are relevant to a particular business process. Another, technical development track produced Business Process Management Systems (BPMS) that had a goal of enabling an efficient way of creating specialized automated process implementations for any purpose by different enterprises. The first wave of commercial systems used automated generic processes that were similar among many enterprises, or were custom built from the ground up to the requirements of a specific business process in an enterprise. New BPMS implementations claimed that they could automate any process in the enterprise involving both human participants and other computer applications.

Business Process Management systems are often model driven, e.g., they execute a formal model that defines the workflow of the automated process. A common technology to implement the model is the Business Process Execution Language (BPEL), but numerous other modelling languages have also been developed. In some cases the model describes the structure of the state data of the process, and a sequence of interaction steps by external participants to modify the state. The model can also describe other resources, such as databases, needed by the process.

An important variant of systems for business communication are the document based messaging systems (document-flow systems) described in the following. Business Process Management systems are inherently centralized systems where all the participants need to be able to access a common, shared process instance. Attempts have been made to create distributed BPM systems where each participant is either accessing a virtual copy of the shared process instance (REF) or only has its relevant part of the process description available locally. These systems, however, loose many of the benefits that a BPM system is supposed to deliver.

In an illustrated embodiment, a distributed document-flow based service is provided for small and medium sized enterprises with individual professional users and consumers who interact frequently, such as daily. This embodiment supports one or more individual users who have no access to a fixed internet connection or a personal computer but rely entirely on their mobile device instead. In this domain, it is not possible always to identify an owner for a process—typically the participants can be peers to each other. The users form complex networks that they manage dynamically as their business contacts evolve. These networks constitute the backbone for all communication within the daily processes for users of this embodiment.

As seen in FIG. 1A, a network includes service providers 102 and customers 104, whereby service provider (SP) nodes 106, 108, 114 and 124, interact with service customer (SC) nodes 118, 120 and 126. It is noted that all nodes are depicted as head-to-shoulder icons in FIGS. 1A and 1B to indicate that each of the depicted nodes has an associated user. Among SP nodes there is a colleague relationship 112 among node 106 and node 108 in subset network 110, such as among business partners who divide a geographical area, and peer to peer relationships 128 among node 108 and node 114 in subset network 116, and node 114 and node 124. Between a SP node and a SC node is a provider/customer relationship 130, e.g., between SP node 106 and SC node 120, between both SP nodes 108 and 114 with SC node 118, and between SP node 124 and SC node 126. Among SC nodes there is a peer to peer relationship 132 among node 120 and 118 in subset network 122, and between node 118 and node 126, such as between two handsets in direct wireless communication range. This network can be complex, involving multiple subset networks among the user in the domain. The networks can be somewhat informal in their nature, like “myNeighbors”, or businesslike and more formal as “myCustomers”. All daily processes are conducted among these networks.

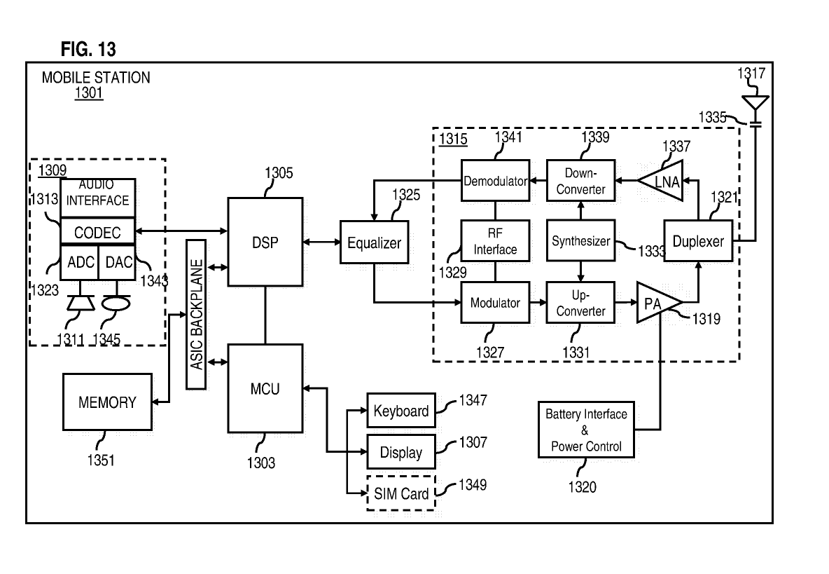

In various embodiments, nodes 106, 108, 114, 118, 120, 124 and 126 can be any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, audio/video players, digital cameras/camcorders, televisions, digital video recorders, game devices, positioning devices, or any combination thereof. Moreover, the nodes may have a hard-wired energy source (e.g., a plug-in power adapter), a limited energy source (e.g., a battery), or both. It is further contemplated that the nodes can support any type of interface to the user (such as “wearable” circuitry, etc.). In the illustrated embodiment, node A node may be a wireless mobile terminal (also called a mobile station and described in more detail below with reference to FIG. 13).

By way of example, a communication network (not shown) can include one or more wired and/or wireless networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network, or any combination thereof. In addition, the wireless network may be, for example, a cellular network and may employ various technologies including code division multiple access (CDMA), wideband code division multiple access (WCDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. Information is exchanged between network nodes in the network according to one or more of many protocols (including, e.g., known and standardized protocols). In this context, a protocol includes a set of rules defining how the nodes interact with each other based on information sent over the communication links. In various embodiments, the communication network, or portions thereof, can support communication using any protocol, for example, the Internet Protocol (IP).

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. In a peer-to-peer model of computer process interactions, each process is equivalent and may have aspects of both a client process and a server process, e.g., either initiating interaction or responding to a request, or both.

Providing for intermittent mobile clients and peers places demands that the existing process centric workflow modelling and management systems cannot satisfy. For example, in various embodiments: 1) all participants are capable of performing relevant (daily) activities without network access to a central service; 2) the process concepts map directly to the existing physical document based processes to facilitate the understanding of the concepts by the service participants without a steep learning curve; 3) the system facilitates maintenance of application specific networks of contacts for each participant (similar to distribution lists in email context); and/or, 4) the system supports controlled sharing of data resources within the same communication architecture used for the flow implementation. The illustrated embodiment is a document centric workflow model that is based on a message passing paradigm. The model promotes participant autonomy and push type activity assignment.

FIG. 1B is a diagram of document flows in the network of FIG. 1A, according to one embodiment. The nodes 106, 108, 114, 118, 120, 124 and 126, and subset networks 110, 116 and 122 are as described above for FIG. 1A. In the illustrated embodiment, a request document 150 is sent from SC2 at node 118 to SP2 at node 198. The request is delegated by sending delegate document 140 to colleague SP1 at node 106. In response, a report document 148 is generated at node 106 and sent to SC2 at node 118. The report document 148 serves as a basis for a recommend document 142 sent from node 118 to SC1 at node 120. The customer SC2 at node 118 also sends an invite document 144 to SC3 at node 126 and invite document 146 to SP4 at node 124.

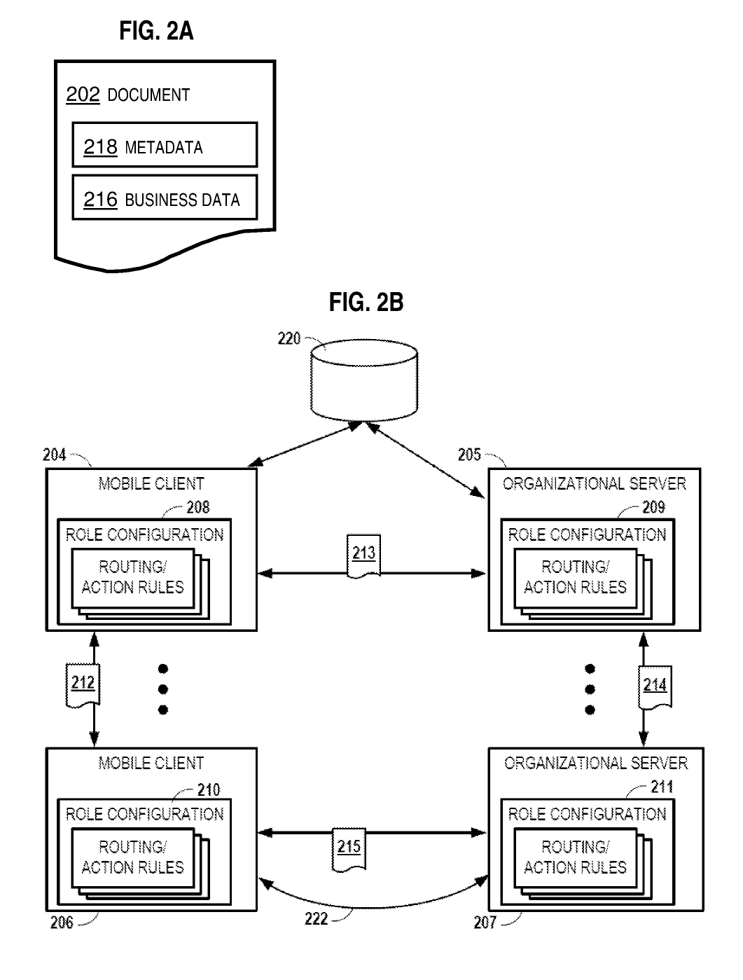

FIG. 2A is a diagram of a document 202 for a document-flow based service, according to one embodiment. The document 202 includes business data 216 that indicates information to be understood, changed or acted upon by a human viewer and metadata 218 that describes the document for proper automated handling and management. In general, metadata comprises data representing values in one or more data fields corresponding to metadata parameters. In an Extended Markup Language (XML) document, the data field name, e.g., the metadata parameter name, is included with the corresponding value for the field, both often expressed as character strings. Typically, an XML document indicates a parameter name and parameter value for all data included in the document, and allows one parameter to be nested in another. The type, number and allowed nesting of parameters for an XML document of a particular type are specified in an XML dictionary file shared among all nodes that will use XML documents of that type. The XML document begins with a field specifying the XML document type and associated XML dictionary.

As used herein, business data 216 refers to any data for human use, irrespective of the application. Thus, in one embodiment, a document-flow based service can be used for business applications such as customer orders and internal enterprise management functions, like a travel service, as well as non-business applications, such as patient and medical services, engineering design and approval services, legal services, and academic processes such as course registration and manuscript preparation, among others.

In a document flow framework described herein, task management can be handled by organizing documents into “threads,” where each thread corresponds to a process. In the past, the concept of threads has been associated with email exchanges, online message boards, text message exchanges, Usenet groups, etc. In those types of communications, ongoing communications are grouped into threads according to a particular message or subject. The communications may be presented in some order (e.g., sorted by time created/received) and may be hierarchically arranged based on other factors (e.g., responses to a particular message may be grouped beneath the originally posted message).

As such term is used generally herein, threads are a data paradigm used to illustrate states and relationships of ongoing transactions. For example, the term “thread” may refer to data/executable objects that reside in user devices that reflect states of the underlying transactions. This thread object may also have a visual presentation component. The ongoing transactions represented by threads may include transfer of documents, tangible assets, written or verbal communications, etc. Further, the processes that are represented by threads need not be associated with for-profit entities. Therefore, although example “business processes” may be described herein in terms of business organizations, those of skill in the art will appreciated that a “process” or “business process” may include any form of tasks utilizing electronic message exchanges that collectively accomplish a defined goal in an orderly fashion. For example, common tasks performed by individuals, such as organizing a party, fundraising, community awareness, circulating petitions, etc., may involve exchanges that could be tracked via electronic messaging and represented as threads to participants.

In one embodiment, a document thread may have a state which describes the current overall state of the business process, e.g. “Order sent,” “Delivery received,” etc. Sub-processes can be represented as nested threads. A user interface that represents documents as threads may be sufficiently close to email to give users an intuitive understanding of how to use it. However, such a system may exhibit differences from standard email. For example, standard email may not support the full metadata needed to manage the document-flow based service or adapt well to different services or different views into the same database.

FIG. 2B is a diagram of document flow for a document-flow based service, according to one embodiment. The illustrated embodiment includes communication flows in a distributed mobile document system. The participants of the flow communicate by sending documents (e.g., document 202) to each other. The communication nodes (e.g., mobile clients 204, 206 and servers 205, 207) may be “store-and-forward” type processing nodes that facilitate easy and intuitive operation in difficult connectivity conditions. The nodes 204, 205, 206, 207 include respective role configuration modules 208, 209, 210, 211 that each maintain and apply metadata extraction/display/routing/action rules for processing and routing various documents 212-215 that circulate through the system. The nodes can be either mobile clients that represent the individuals participating in a document flow out in the field. Some participants can be organizations that are assumed to be fixed in nature. The organizations are represented by server systems. For example, a mobile sales agent in the field can send “purchase order” documents to the server that represents his company. However, the flow does not necessarily have any organizational participants.

The participants of the flow communicate by sending documents to each other. The communication media is assumed to be “store-and-forward” type to enable easy and intuitive operation in difficult connectivity conditions.

Both the mobile users and organizations have a role defined with respect to the document flow. For example, in a document flow that implements a mobile ordering process one might have roles “Sales agent”, “Customer”, “Provider company” and “Order handler”. The role of a mobile user defines a set of display and action forms that control how the user sees the incoming documents. For example, an “Order Confirmation” document in the ordering flow might appear to have some extra data for the “Sales agent” compared to the “Customer”. Also the “Sales agent” might have access to “Cancel Order” function on the order while the “Customer” might see “Request Order Cancellation” action on his order form.

By way of example, each document in the system carries the business data that is relevant to the application of the flow, e.g., order rows. In addition, each document has structured metadata that can be interpreted by all participants of the flow and used for various purposes. For instance, the forms used to handle a document are selected based on the user's role and document type. Therefore, the user's role is defined for every document that is received. To ensure this, the receiving user's role is bound to a node before a document is sent to the node. In some embodiments, a central server stores information that binds a role to a node of the network.

It is contemplated that metadata, in certain embodiments, can be extracted (or created) based on other content within the document, such as this business data. In one embodiment, functions and/or filters can be created based on the business data of, for example, a purchase order document using metadata extraction rules.

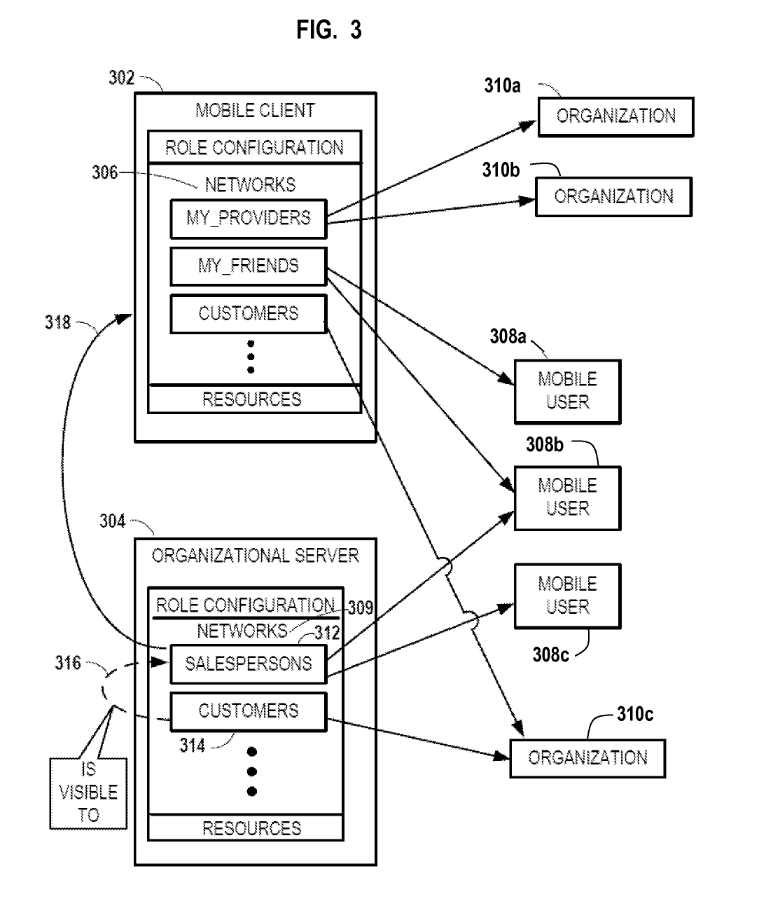

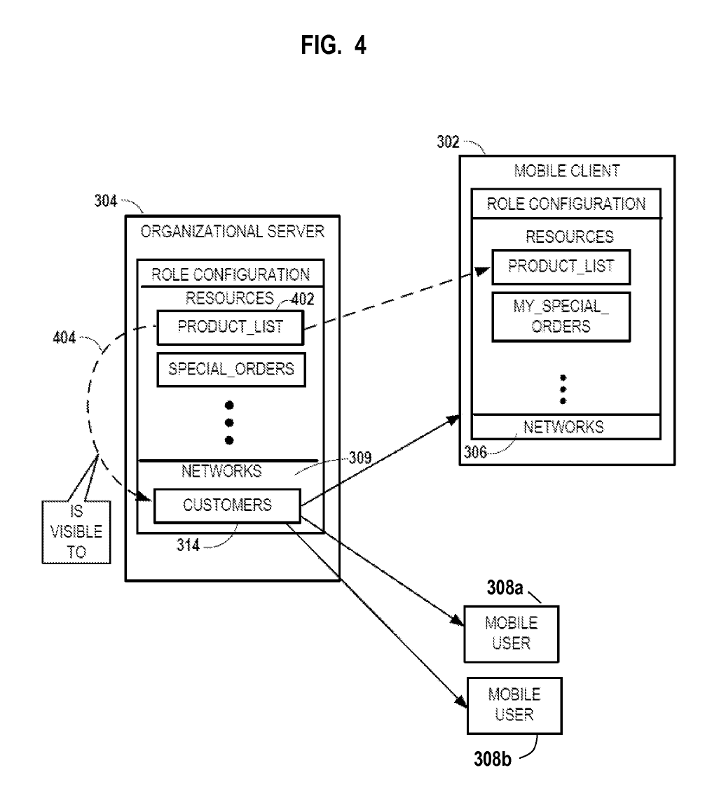

FIG. 3 is a diagram of modules in a distributed mobile document flow system; according to one embodiment. Module 302 is a mobile client module; and module 304 is an organization server module. These modules communicate with each other over a network and refer to users of other nodes represented by organizations 310a, 310b, 310c (collectively referenced hereinafter as organizations 310) and mobile users 308a, 308b and 308c (collectively referenced hereinafter as mobile users 308). Both types of modules are configured for a role of predetermined functions and permissions, and maintain addresses of network resources, and maintain addresses of network contacts 306 and 309 (simply called “networks” in FIG. 3), respectively, sometimes broken down into one or more separate networks of contacts. Mobile clients are configured to maintain all contact lists (or other software objects) that are needed to initiate document flows with other mobile users 308 or organizations 310. Some of the contact lists (e.g., “My Providers” and “Friends”) can be private and maintained only inside the user's phone. Other contact lists (e.g., “Customers” 314 and“Salespersons” 312) can be maintained by the organizational servers and automatically synchronized to other contact lists maintained in the organization. The Customers list 314 can be defined to be visible via relationship 316 to users listed in the Salespersons list 312; and, the system takes care of communicating the changes of customers lists to the mobile clients of the salespersons, e.g., by messages 318. The lists of network participants maintained by a mobile user or an organization define the space of participants with whom the user or organization can initiate flows.

FIG. 4 is a diagram that illustrates resources in the distributed mobile document flow system, according to one embodiment. Modules 302, 304, mobile users 308a, 308b, network contact lists 306, 309 and Customers list 314 are as described above for FIG. 3. Each module also maintains list (or other software object) of resources, e.g., Product List 402 and Special Orders. In various embodiments, a resource is a tabular array of data, for example a “Product List” 402 of a company, or binary data like an image. The forms use the locally available resources in their user interface (UI) active elements (called widgets). For example an “order” form can show a selection list of products that it has fetched from the Product List resource 402 on server 304. The management and visibility of resources is controlled in a similar way to the networks of contacts. A resource can be managed either locally by the mobile client or by an organization which can define the visibility of that resource to given networks, e.g., the “is visible to” relationship 404 depicted in FIG. 4. The system is responsible for sending the changed resource to the network contacts for which it has been defined visible.

In certain embodiments, the resource is managed by an organization at the organizational server and is synchronized as such to the whole given network. For example the Product List resource can be visible to the “customers” network contacts, as indicated by relationship 404. In this case, all the customers see the same product list. Sometimes it is useful to create dynamically managed views to the resources that can be distributed to different networks. In such case, the tabular resource format can be tagged row by row to be visible in different networks of contacts. For example, an organization might have the customers segmented in “keycustomers” and “regularCustomers”. Thus, some rows in the product list may be tagged visible only to the “keyCustomers”.

Although a particular set of nodes, modules, and data structures are shown in FIG. 1A, FIG. 1B, FIG. 2A, FIG. 2B, FIG. 3 and FIG. 4 for purposes of illustration, in various other embodiments more or fewer nodes, modules and data structures are involved. Furthermore, although modules and data structures are depicted as particular blocks in a particular arrangement for purposes of illustration, in other embodiments each module or data structure, or portions thereof, may be separated or combined or arranged in some other fashion.

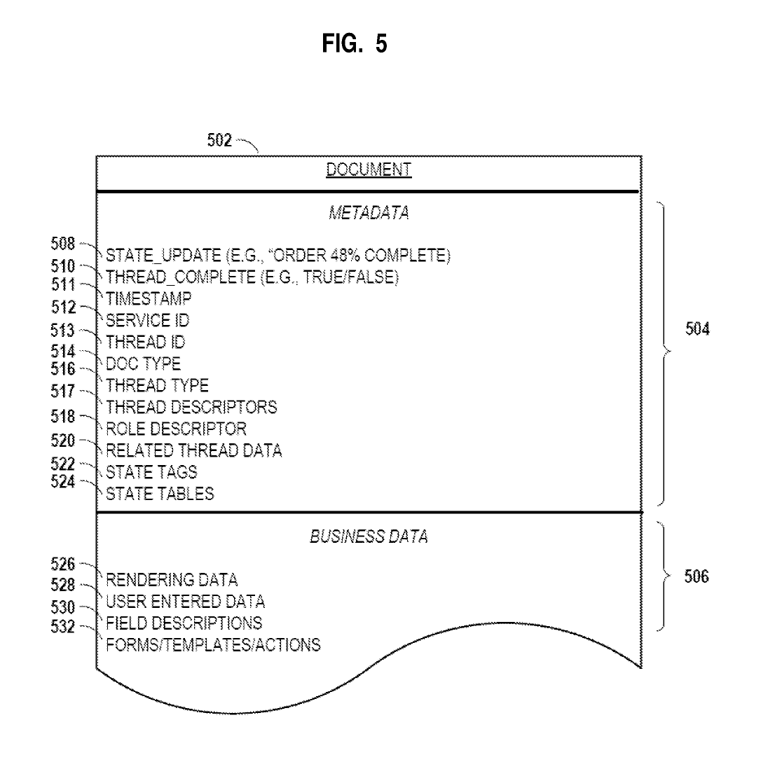

FIG. 5 is a diagram of document metadata and business data, according to one embodiment. The document 502 includes metadata 504 and business data 506. Example metadata 504 includes fields holding values for corresponding metadata parameters. In the illustrated embodiment, the metadata parameter fields include state update field 508, thread complete field 510, timestamp field 511, service identifier (ID) field 512, thread identifier (ID) field 513, document type field 514, thread type field 516, thread descriptors field 517, role descriptor field 518, related thread data field 520, state tags field 522 and state tables field 524.

Example business data 506 includes fields holding values for corresponding business parameters. In the illustrated embodiment, the business parameter fields include rendering data field 526, user entered data field 528, field descriptions field 530, and forms/templates/actions fields 532.

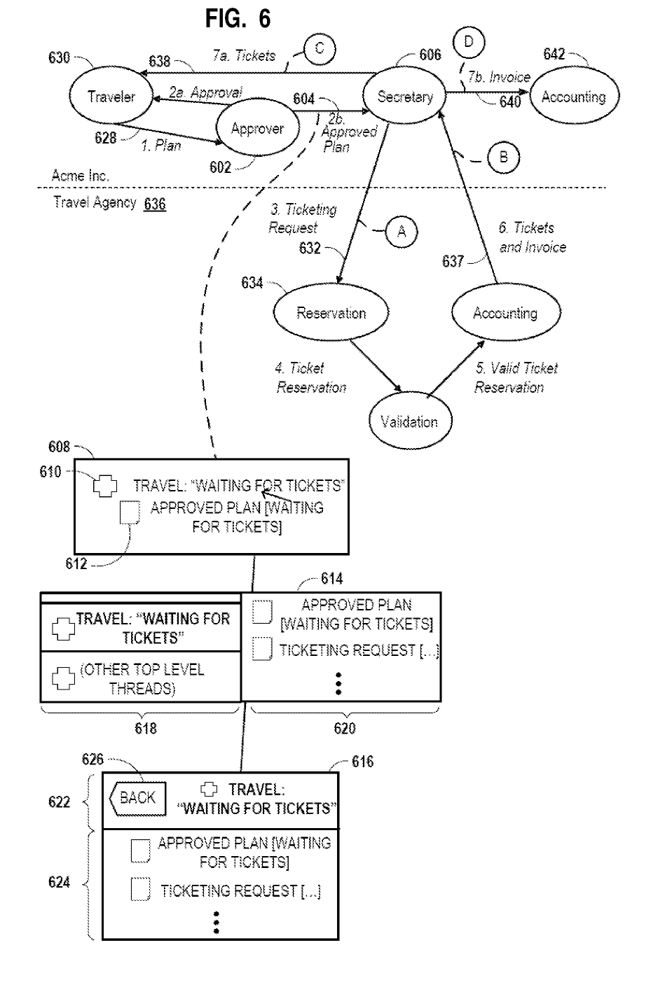

FIG. 6 is a diagram of a document flow for a document-flow based travel service in an organization, according to one embodiment. In FIG. 6, nodes for various roles (e.g., Approver node 602) are shown as vertices of a directed graph, with documents (e.g., Approved Plan 604) shown as edges of the graph. The graph in FIG. 6 relates to a particular example of document flow in support of travel planning and ticket reservation. In particular, the views of the document management system (e.g., view 608) are customized for the role of a secretary at secretary node 606 who processes a number of steps in the travel planning and ticket purchasing operations.

When the secretary node 606 has received the Approved Plan document 604, his/her user interface will show a threaded document flow, such as shown in block 608. The cross-shaped symbol 610 denotes a thread, and the paper symbol 612 denotes a document belonging to the thread. It is noted that while threads are shown here as a fully opened tree view, they could also be displayed one level at a time, similar to a file system. The latter may work better on a mobile device, where limited horizontal screen space makes indentation difficult. Examples of alternate views are shown in blocks 614, 616. In view 614, the selected level of the hierarchy (here the thread level) is shown in left pane 618, and items below the selected level are shown in right pane 620. In the view 616, each hierarchal level is displayed in a “flat” view, with a header portion 622 indicating the current “container,” and a list portion 624 showing all of the items within the container. The user navigates up the hierarchy by selecting control 626, and down the hierarchy by selecting an item from the list 624. Other views known in the art (e.g., directed graph, annotated list, etc.) may also be used as appropriate to the solution domain and target user interfaces.

The travel thread 610 is this instance is established for viewing the process relative to the secretary's role. Thus the travel thread 610 is created in this scenario when an Approved Plan document 604 is received by the secretary node 606. Although a travel thread could conceivably be created by some earlier event, e.g., when traveler node 630 submits the initial plan 628 to approver node 602, this thread is particular to the secretary node 606, which may not have any knowledge of that document 628. The Approved Plan document 604 contains a descriptor for the Travel thread, which may include the subject of the thread (“Travel” or “Travel for Traveler initiated on Date”), a unique thread ID, and possibly the ID of the thread's parent thread (in case of nested threads). Since this is the first document belonging to the thread that the client process on secretary node 606 has received, no corresponding thread is found on the secretary node 606, so a new thread is created and the document is attached to it.

The state of the new thread (shown in quotation marks in text associated with icon 610) is set from the StateUpdate field (e.g., field 508 in FIG. 5). The contents of the StateUpdate field are shown in brackets in the descriptive text accompanying icon 612. It is noted that the bracketed text and arrow shown in view 608 are for purposes of showing the relationship/updates between StateUpdate of the document 612 and state of the thread 610, and is not necessarily part of the user interface.

The secretary node 606 next opens the Approved Plan document 604. The form used to open the document allows the secretary node 606 to send a Ticketing Request document 632 to the reservations role 634 of travel agent 636. The form copies the Travel thread descriptor to the new document 632. In this example, this portion of the process (e.g., steps taken by agency 636) has been modeled as a sub-process when creating the service. Thus the form also attaches a new thread descriptor “Ticketing” to the document 632, marks the new thread descriptor as the immediate parent of document 632, and marks the old “Travel” thread descriptor as the parent of the new thread descriptor. The StateUpdate field (e.g., field 508 in FIG. 5) is set by the form to contain the text “Tickets Ordered.

A document 637 containing the tickets and the invoice arrives from the travel agency 636. The secretary node 606 next opens the Tickets and Invoice document 637. The form used to open the document may include a button for forwarding tickets 638 to the traveler 630. The secretary checks the information and then presses the “Forward to traveler” button. The form knows that the new Tickets document does not belong in the Ticketing thread, and removes the Ticketing thread descriptor from the Tickets document and makes the remaining Travel thread descriptor the immediate parent of the document.

The secretary node 606 later processes all invoices (e.g., at the end of the month). This is performed by opening the Tickets and Invoice document 637 again, but pressing “Forward to accounting” button this time. The form requires the user of secretary node 606 to fill in budget-related information (cost codes, estimates etc.) and once complete, sends the Invoice document 640 to accounting node 642. This time (based on use of a different button) the form sets the StateUpdate field of the new document to “Invoice Sent.” The change of status causes a change in the status of the travel thread, and will also cause the thread to be marked as complete for the secretary node 606, based on a configured role-specific list of status values which signify thread completion, and/or or the thread complete field 510 in document metadata 504.

In a document flow system, each client system, a mobile or fixed computer, is normally configured to render the documents in the UI (User Interface) according to the role of the user using that computer. For example a manager can have a different view to a travel expense claim document and its related documents than a secretary or the traveller. Some related documents, like the allocated travel budget for the traveller, might only be visible to the manager of the traveller. A document is first visible to a user when it appears in a list of available documents in a UI, e.g., represented by a subset of the metadata and displayed as an icon, as a view into a database of documents on the node. A selected document in the list is then subsequently opened in a form that allows an action appropriate to a role performed by the user of the node.

A problem can arise if a function associated with one role in a document flow is assigned to a user having a different role, e.g., to tailor the functions for an individual or to temporarily delegate a function. For example, the manager could delegate his/her approval rights to his secretary within some constraints. In a document flow system where each client is statically configured to conform to a particular role this would mean reconfiguring the software in the secretary's client device. Technically this is possible, but if nodes are configured at the level of a limited number of predefined roles, then for a secretary's node to take on a function that appears in the manager's role, forces the system to configure the secretary's node for all other managerial functions as well. This is often not a desired result.

A straight forward solution would be to have a special “secretaryWithTravelClaimApprovalRights” configuration for secretaries with temporal approval rights. This, however, requires static analysis and modelling of all possible delegation patterns within the service in advance, thus increasing the complexity of the document flow models combinatorially. This amounts to an attempt to tailor the roles to fit the actual responsibilities of many actual participants; and, leads to a large number of permutations of functions and roles, which represents a great burden to the persons responsible for configuring the nodes.

According to the illustrated embodiments, a special form of metadata is attached to or included in the documents. The special form of metadata contains information on how the document is shown in relation to other documents (or threads) in the device UI. This information is structured according to the function, not the role, of the user. This metadata includes a set of filters that are applied to the database containing all documents in the device to produce a closure set of relevant documents. A filter is a function that accepts a document identifier as input and returns a value of true or false. A document for which true is returned is included in the view to a database; a document for which false is returned is not included in the view.

For example, metadata called “TravelClaimApproval” includes filters to fetch the travel plan and travel budget documents to the UI view. This function would normally be applied by the “Manager” role, however the node for the “Secretary” role (or any other role for that matter),or a node for a particular user who has the secretary's role, is temporarily or permanently configured for this function.

This way there does not need to be an excessively exhaustive set of roles to cover all combinations of functions with the associated predesigned configurations for all possible delegation situations among client roles. The delegation of functions can happen at will between nodes of any roles in the document flow. The access rights to the delegation can be managed in traditional way and configured into the role itself, e.g., the manager can perform the delegation but the secretary cannot.

In these embodiments, the documents themselves carry the filtering information in their metadata instead of the client configuration files in the devices/nodes. This makes ad hoc document routing (e.g., delegation, forwarding) during document flow processes much more flexible.

The functional filters for documents can be implemented as a set of metadata attributes structured according to the function they relate to. They can be attached to the documents in a similar fashion as other metadata such as creation date and time, creator, subject information, document type etc.

Typically the document view in the UI would consist of document threads where each thread includes all related documents, e.g., all documents relating to a single task or activity.

An advantage of this embodiment is that the document flow model is much simpler, because all possible document management UI views do not need to be preconfigured into the clients. The later assignment or delegation of functions in the document flow is simpler and more dynamic and can be controlled and managed through traditional access rights mechanisms. In some embodiments, the filter metadata is protected using cryptography to prevent tampering and forbidden access to the filtering functions.

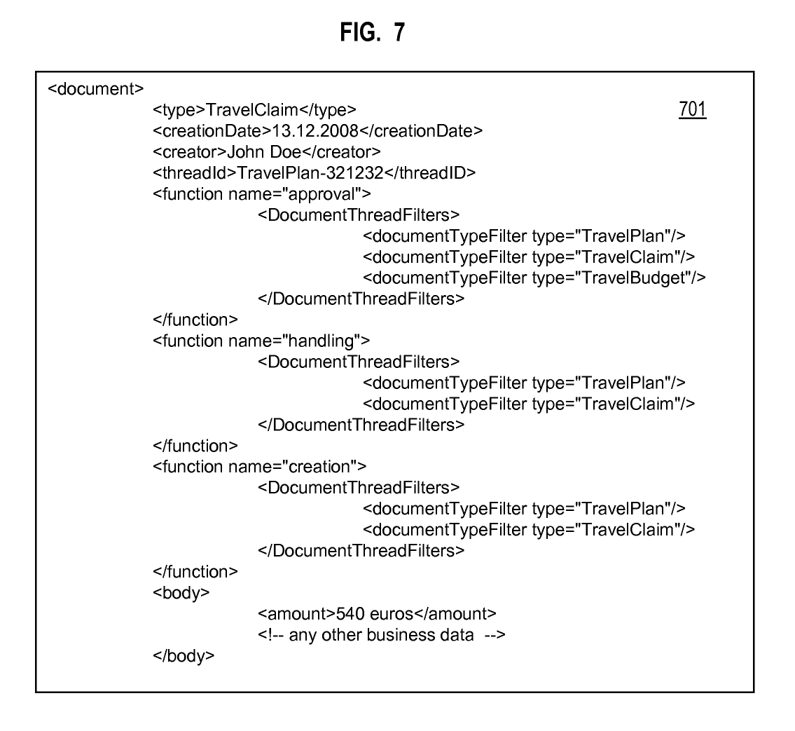

FIG. 7 is a diagram of an XML document 701 that includes filters by function, according to one embodiment. It is assumed for purposes of illustration that the client device (node) of the manager is configured to use “approval” function for these documents; and the node of the secretary uses the “handling” function; and a node of a traveller uses the “creation” functions.

As evident in XML document 701, the function name “approval” is associated with the document thread filters for document type “TravelPlan” and document type “TravelClaim” and document type “Travel Budget.” This means any node where the user is permitted to approve travel claims, for at least one transaction (thread), the view to the document database will include listing for all three document types for that thread.

Similarly, the function name “handling” is associated with the document thread filters for document type “TravelPlan” and document type “TravelClaim” but not document type “Travel Budget.” This means any node where the user is permitted to handle travel claims, for at least one transaction (thread), the view to the document database will include listing for only two document types for that thread. A similar filter is used for the creating function.

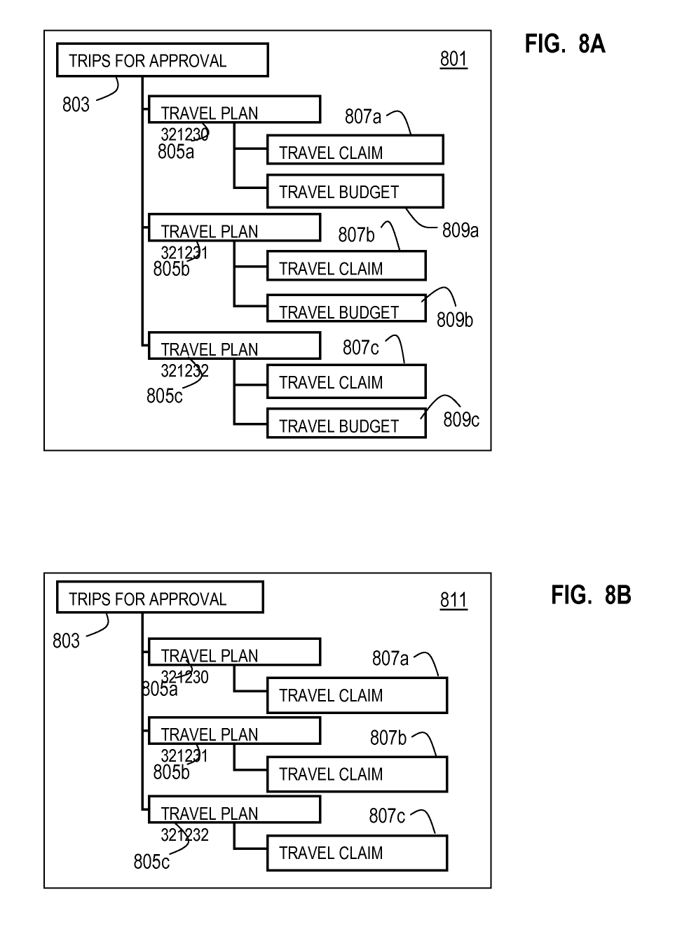

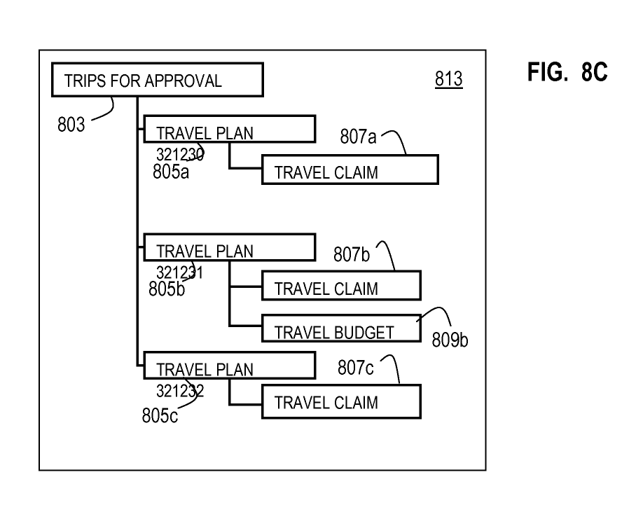

FIG. 8A is a diagram of a view 801 for a first function based on the filters of FIG. 7, according to one embodiment. The view lists documents associated with the thread type called “trips for approval” associated with this one kind of transaction. It is assumed for purposes of illustration, that there are three instances of such transactions in the documents database, one associated with thread 321230, another with thread 321231, and a third with thread 321232. It is further assumed for purposes of illustration that each thread instance is initiated with a travel plan document. Thus, in view 801, the thread type is indicated by the value “trips for approval” in field 803, and the three different threads of this type are indicated by the corresponding initial documents “TravelPlan 321230” in icon 805a, “TravelPlan 321231” in icon 805b, and “TravelPlan 321232” in icon 805c. As used herein, the term icon refers to a portion of a visual display including graphics or text or both, and may be implemented as a software object.

Under this scenario, it is further assumed that the view 801 is for a node that is permitted to perform the travel “approval” functions for all TravelPlan threads in the document database. According to the special metadata in XML document 701, a view for the approval function includes in the view of TravelPlan threads, the documents types TravelPlan, TravelClaim and TravelBudget. Thus view 801 shows TravelClaim in icon 807a and TravelBudget in icon 809a along with TravelPlan 321230 in icon 805a for the first thread. Similarly, view 801 shows TravelClaim in icon 807b and TravelBudget in icon 809b along with TravelPlan 321231 in icon 805b for the second thread; and TravelClaim in icon 807c and TravelBudget in icon 809c along with TravelPlan 321232 in icon 805c for the third thread.

FIG. 8B is a diagram of a view 811 for a second function based on the filters of FIG. 7, according to one embodiment. It is further assumed that the view 811 is for a node that is permitted to perform the travel “handling” functions for all TravelPlan threads in the document database. According to the special metadata in XML document 701, a view for the handling function includes in the view of TravelPlan threads, only the document types TravelPlan and TravelClaim, but not TravelBudget. Thus view 811 shows TravelClaim in icon 807a along with TravelPlan 321230 in icon 805a for the first thread; TravelClaim in icon 807b along with TravelPlan 321231 in icon 805b for the second thread; and TravelClaim in icon 807c along with TravelPlan 321232 in icon 805c for the third thread.

FIG. 8C is a diagram of a view 813 for a limited first function based on the filters of FIG. 7, according to one embodiment. It is further assumed that the view 813 is for a node that is permitted to perform the travel “handling” functions for all TravelPlan threads in the document database and “approval” under certain conditions. Any conditions may be used to limit the approval function, such as time (e.g., while manager is on vacation), metadata values (e.g., for certain travelers) or business data values (e.g., budgets less than $1000), alone or in any combination. It is further assumed that only travel plan 321231 satisfies those conditions. According to the special metadata in XML document 701, a view for the handling function includes in the view of TravelPlan threads, only the document types TravelPlan and TravelClaim, but not TravelBudget, unless those conditions apply Thus view 811 shows TravelClaim in icon 807a along with TravelPlan 321230 in icon 805a for the first thread; TravelClaim in icon 807b and TravelBudget in icon 809b along with TravelPlan 321231 in icon 805b for the second thread; and TravelClaim in icon 807c along with TravelPlan 321232 in icon 805c for the third thread.

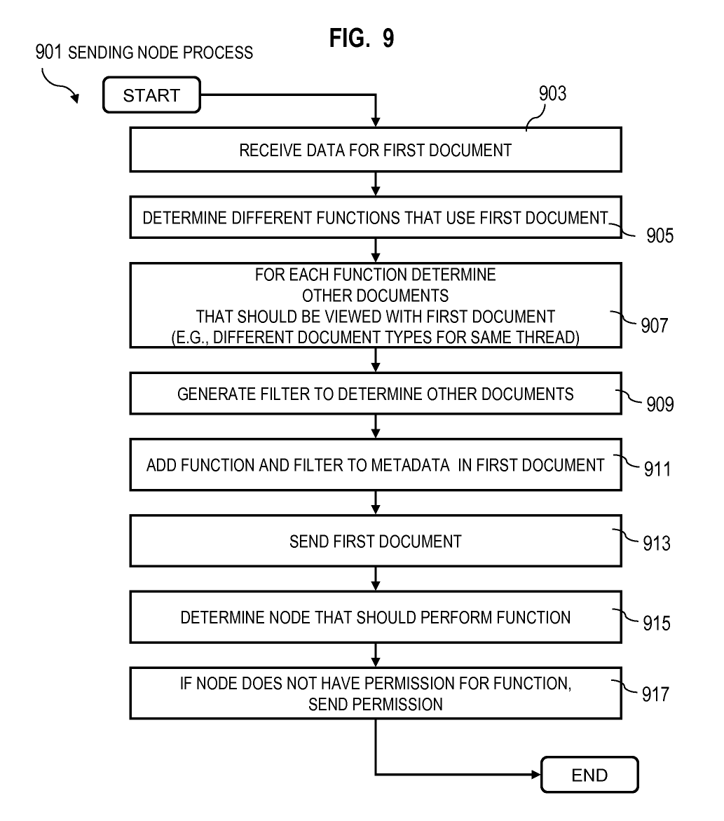

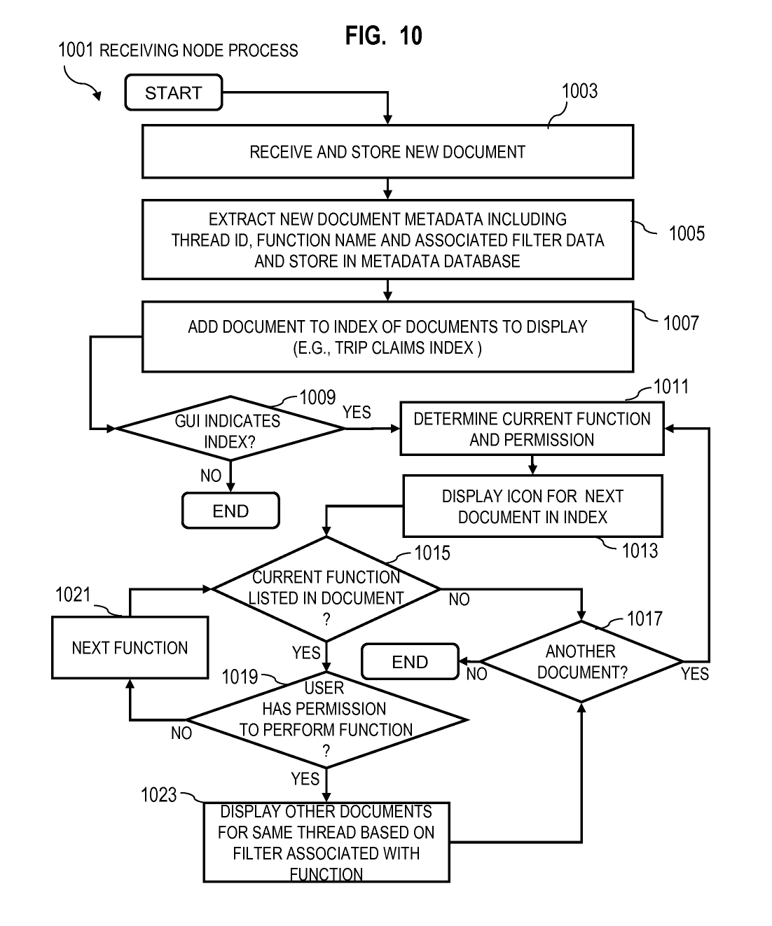

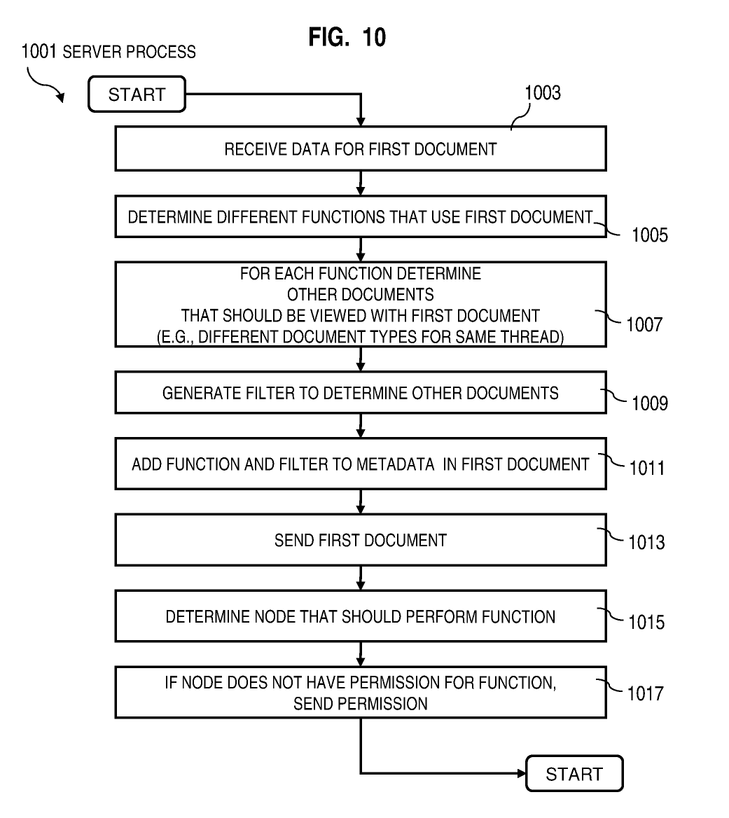

FIG. 9 is a flowchart of a process 901 on a sending node, according to one embodiment. Although steps in FIG. 9 and subsequent flow chart FIG. 10 are shown in a particular order for purposes of illustration, in other embodiments, one or more steps may be performed in a different order or overlapping in time, in series or in parallel, or one or more steps may be omitted or added, or changed in some combination of ways.

In step 903, data is received for a first document. Any method may be used to receive this data. For example, in various embodiments, the data is included as a default value in software instructions, is received as manual input from a network administrator on the local or a remote node, is retrieved from a local file or database, or is sent from a different node on the network, either in response to a query or unsolicited, or the data is received using some combination of these methods.

In step 905, one or more functions are determined that use the first document. For example, the first document is a document of type TravelPlan and it is determined in step 905 that documents of type TravelPlan are used in functions for creating a travel claim, handling travel claims, approving travel claims as well as other functions, such as planning travel, budgeting travel, reserving accommodations and purchasing tickets.

In step 907, the other documents that should be viewed with the first document for each function are determined. For example, it is determined in step 907 that for creating a travel claim and handling a travel claims, only the TravelClaim type documents should be viewed with the first document, a TravelPlan type document; while for approving a travel claim both the TravelClaim type document and the TravelBudget type documents should be viewed with the first document.

In step 909, a filter is generated to determine the other documents to be viewed. For example a Boolean expression is constructed that specifies the documents to pass, e.g. Boolean expression 1:

doctype=TravelPlan OR doctype=TravelClaim OR doctype=TravelBudget (1)

where “doctype” refers to a metadata parameter for document type. In an illustrated embodiment only the document types to be passed are listed, as in XML document 701, and not the full Boolean expression. In this embodiment, the Boolean expression is constructed by the client process based on the list of document types to pass indicated in step 909. In some embodiments, the filter specifies pass ranges for metadata or business data instead of or in addition to document type. For example the filter only passes travel budget documents for travel claim amounts under 1000 euros as given by

doctype=TravelPlan OR doctype=TravelClaim OR (IF amount<(1000 euros ) THEN doctype=TravelBudget) (2)

In step 911, the filter and associated function is added to the metadata in the first document. For example, a function name parameter is added to an XML document for each function, as depicted in FIG. 7. In some embodiments, the function and filters are encrypted so that only authorized nodes are able to access the filters.

In step 913, the first document including metadata is sent to another node. For example, approver node 602 sends to secretary node 606 a TravelPlan document 701 with metadata showing the other documents to view for each function.

In step 915, it is determined which node should be able to perform each of one or more function. For example, approver node 602 determines that secretary node 606 should perform the approval function, at least under certain conditions.

In step 917, if the node to perform the function does not have permission to perform that function, then the permission to perform that function is sent to the node. For example, in step 917, the approver node 602 sends approval permission to secretary 606, at least for the certain conditions. It is assumed for purposes of illustration that the secretary role does not include the approval function. For example, the permission is sent to secretary node 606 for approval functions for a one week time window. When used with a filter given by Boolean Expression 2, the secretary is only allowed to see travel budgets type documents for travel claims having total costs less than, for example, 1000 euros during that week.

Any method may be used to send these permissions, e.g., through a key exchange protocol to pass keys to decrypt encrypted filters, or through a trusted messaging service. In some embodiments, permission is conveyed in the first document. In some embodiments, permission to send documents or functions are cleared at a central server, and a receiving node can contact the central server to verify that the sender has authority to give the permissions received.

In some embodiments, the functions for the nodes in the network are determined by another node and steps 915 and 917 are omitted. In some embodiments, the functions for the nodes in the network are determined statically during initial configuration, and steps 915 and 917 are omitted.

FIG. 10 is a flowchart of a process 1001 on a receiving node, according to one embodiment. In step 1003, a new document is received and stored in the document database at the node. It is noted that in some embodiments, the receiving node for some filters associated with a function is a sending node for the same or different other filters associated with the same or different other function. In step 1005, the metadata for the new document is extracted. For example, a thread identifier (ID), a function name and associated filter data are extracted from the new document and stored in the metadata database in association with the document. As mentioned, additionally or alternatively, metadata can be extracted (or created) based on other content within the document, e.g., business data, whereby, functions and/or filters can be created based on the business data using metadata extraction rules.

In step 1007, the document is added to an index of documents to display. It is assumed for purposes of illustration that each node retains one or more indexes of documents to display on each of one or more screens. For example, the document is added to an index of travel claims.

In step 1009, it is determined if a user interface (UI) such as a graphical user interface (GUI) indicates that the particular index including the document is to be displayed. If so, then in step 1011 the current functions and associated permissions are determined. For example, it is determined in step 1011 that the function is travel approval and that the user has only conditional permission to approve travel claims.

In step 1013, the icon for the next document in the index is displayed. The icon presents values for one or more metadata parameters, such as a document type, creation date, thread ID as well as an optional graphic. For example, icon 805a presenting “Travel Plan 321230” is displayed, as shown in FIG. 8C.

In step 1015, it is determined whether the current function is listed in the document. For example, it is determined if the approval function is listed in the Travel Plan document 701. If not, then in step 1017 it is determined whether there is another document in the index. If not, the process ends. Otherwise, control passes back to step 1013, described above, to display the icon for the next document in the index.

If it is determined in step 1015 that the current function is listed in the document, then, in step 1019 it is determined if the user currently has permission to perform the function. For example, in step 1015 it is determine that the approval function is listed in document 701, and in step 1019 it is determined if the conditions for the secretary to have approval authority are satisfied. If not, then the next function is checked, e.g., the next highest function. It is assumed for purposes of illustration that the conditions are satisfied only for the second thread; therefore, in step 1019, it is determined that the user does not have permission to perform the function and control passes to step 1021 to determine the next highest function, e.g., handling.

After step 1021, control passes back to step 1015, described above. For example, the next function is handling which is listed in the XML document 701. Thus control passes to step 1019 again where it is determined that the secretary node 606 has permission to perform handling. So control passes to step 1023.

In step 1023, the icons of other documents for the same thread are displayed based on the filter associated with the function. In the example, the other documents are documents of type TravelPlan and TravelClaim, so these documents types for the first thread are displayed. For example, icon 807a presenting “Travel Claim” is displayed (thread 321230), as shown in view 813 in FIG. 8C.

Control then passes back to step 1017 to determine if there is another document (or thread). In the example, there is another document for the index and control passes to step 1011, where the function is returned to the approval function. In step 1013, the icon for the next document is displayed. For example, icon 805b presenting “Travel Plan 321231” is displayed.

In step 1015 it is determined that approval function is listed in the document, as described above. In step 1019 it is determined that the conditions for the secretary to have approval permission are satisfied for the second thread. In step 1023, the icons of other documents for the same thread are displayed based on the filter associated with the function. In the example, the other documents are documents of type TravelPlan and TravelClaim and TravelBudget associated with the approval function, so these documents types for the second thread are displayed. For example, icon 807b presenting “Travel Claim” and icon 809b presenting “Travel Budget” are displayed (thread 321231), as shown in view 813 in FIG. 8C.

For the last document, the secretary node does not have approval permission, so the handling filter is applied as for the first thread. As a result, icon 807c presenting “Travel Claim” is displayed (thread 321232), as shown in view 813 in FIG. 8C.

Thus, as mentioned, a special form of metadata can be attached to the documents to provide information on how the document is shown in the device UI in relation to other documents (or threads) in a database of documents. This information is structured according to the function, not the role of the user, and includes a set of filters that are applied to the database containing all documents in the device to produce a closure set of relevant documents. Using this approach, there does not need to be predesigned configurations for possible delegation cases for all client roles. The delegation of functions can happen at will between any roles in the document flow. The documents themselves carry the filtering information in their metadata instead of the client configuration files in devices. Consequently, ad hoc document routing (e.g., delegation or forwarding) during document flow processes is made more flexible.

The processes described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

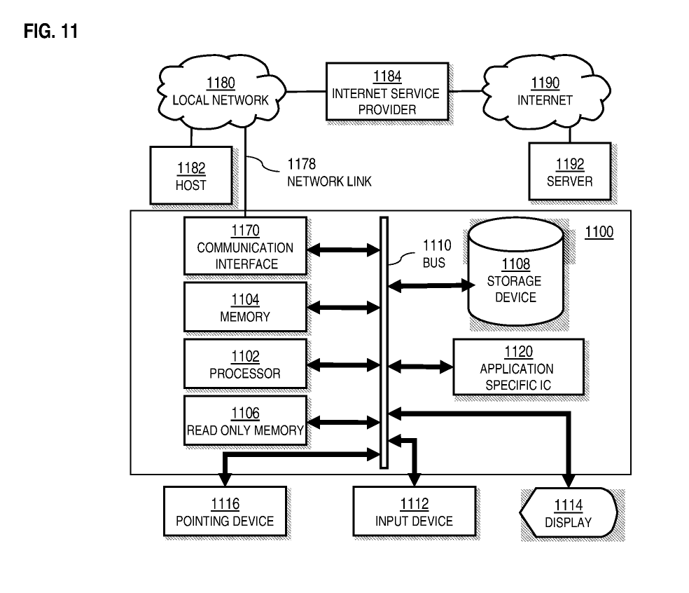

FIG. 11 illustrates a computer system 1100 upon which an embodiment of the invention may be implemented. Computer system 1100 includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information. The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190. A computer called a server host 1192 connected to the Internet hosts a process that provides a service in response to information received over the Internet. For example, server host 1192 hosts a process that provides information representing video data for presentation at display 1114.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

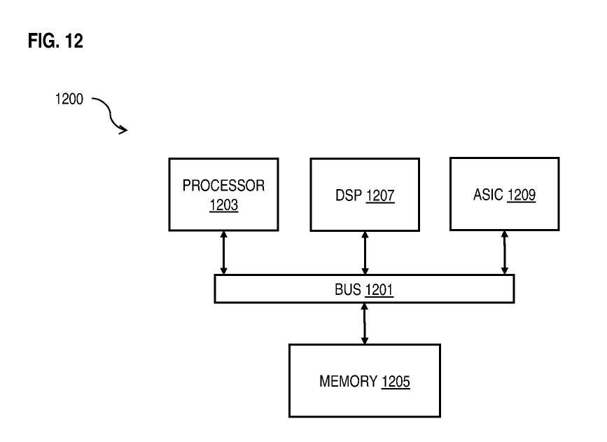

FIG. 12 illustrates a chip set 1200 upon which an embodiment of the invention may be implemented. Chip set 1200 is programmed to carry out the inventive functions described herein and includes, for instance, the processor and memory components described with respect to FIG. 12 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-word signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein. The memory 1205 also stores the data associated with or generated by the execution of the inventive steps.

FIG. 13 is a diagram of example components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303-which can be implemented as a Central Processing Unit (CPU) (not shown).

The MCU 1303 receives various signals including input signals from the keyboard 1347. The MCU 1303 delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
extracting, from metadata in a first document, data that indicates a function and a filter for determining which documents in a database may be viewed to perform the function;
determining whether the function is to be performed; and
if it is determined that the function is to be performed, then initiating display of an icon representing a second document from the database based on the filter.

2. A method of claim 1, further comprising opening a form to present to a user of the apparatus the second document represented by the icon, in response to user input indicating the icon.

3. A method of claim 1, wherein:
a user is associated with a role of predefined functions for a document-flow based service;
the role allows access to the first document;
the second document is different from the first document; and
the icon representing the second document is not otherwise displayed for the role.

4. A method of claim 3, further comprising using, for a thread of related documents, the filter in place of another filter associated with the role.

5. A method of claim 4, further comprising extracting an identifier for the thread from the metadata in the first document.

6. A method of claim 1, further comprising extracting, from a third document, data that indicates permission to perform the function.

7. A method of claim 6, wherein the data that indicates permission to perform the function indicates permission to perform the function for a particular thread of one or more related documents.

8. A method of claim 6, wherein the data that indicates permission to perform the function indicates permission to perform the function for a particular interval of time.

9. A method of claim 1, wherein.
the data that indicates the function and the filter is encrypted; and
the method further comprises extracting, from a third document, a key that indicates permission to perform the function if the key decrypts the data that indicates the function and the filter.

10. A method of claim 1, further comprising:
determining another function that is different from the function and uses a third document;
generating another filter that is different from the filter and determines other documents that should be viewed to perform the different function on the third document; and
initiating sending a document that comprises metadata that indicates the different function and the different filter.

11. A method of claim 10, further comprising sending a message that comprises data that indicates permission to use the different protocol.

12. A method of claim 1, further comprising receiving the first document in at least one of an email message, or a Short Messaging System (SMS) protocol, or a Multimedia Messaging System (MMS), or a instant messaging system (IM) or a Hypertext Transfer Protocol (HTTP).

13. An apparatus comprising:
at least one processor; and
at least one memory including computer program code, the memory and the computer program code configured to, with the processor, cause the apparatus to perform at least the following:
extract, from metadata in a first document, data that indicates a function and a filter for determining which documents in a database may be viewed to perform the function;
determine whether the function is to be performed; and
if it is determined that the function is to be performed, then initiate display of an icon representing a second document from the database based on the filter.

14. An apparatus of claim 13, wherein the apparatus is further caused to open a form to present to a user of the apparatus the second document represented by the icon, in response to user input indicating the icon.

15. A system including the apparatus of claim 13, the system further comprising a different network node configured to:
insert the data indicating the function and the filter into the metadata of the first document, and
transmit the first document to the apparatus.

16. A computer-readable storage medium carrying one or more sequences of one or more instructions which, when executed by one or more processors, cause an apparatus to perform at least the following:
extracting, from metadata in a first document, data that indicates a function and a filter for determining which documents in a database may be viewed to perform the function;
determining whether the function is to be performed; and
if it is determined that the function is to be performed, then initiating display of an icon representing a second document from the database based on the filter.

17. A computer-readable storage medium of claim 16, wherein the processor and the memory are further configured to cause the apparatus to perform opening a form to present to a user of the apparatus the second document represented by the icon, in response to user input indicating the icon.

18. A computer-readable storage medium of claim 16, wherein the processor and the memory are further configured to cause the apparatus to perform:
determining another function that is different from the function and uses a third document; and
generating another filter that is different from the filter and determines other documents that should be viewed to perform the different function on the third document; and
initiating sending another document that comprises metadata that indicates the different function and the different filter.

19. A method comprising:
transmitting a document that includes metadata that comprises data that indicates a function and a filter for determining which documents in a database may be viewed to perform the function.

20. A method of claim 19, further comprising:
transmitting a message comprising data that indicates a recipient has permission to perform the function.
